(19) United States
(12) Patent Application Publication
(10) Pub. No.: US 2013/0089644 A1
(43) Pub. Date: Apr. 11, 2013

(54) DYE EMULSION

(71) Applicants: Andreas Klingenberg, Reinbek (DE); Sascha Anetzberger, Winsen (DE)

(72) Inventors: Andreas Klingenberg, Reinbek (DE); Sascha Anetzberger, Winsen (DE)

(73) Assignee: SENSIENT COLORS EUROPE GMBH, Geesthacht (DE)

(21) Appl. No.: 13/703,277

(22) PCT Filed: Jun. 7, 2011
(86) PCT No.: PCT/EP11/59398

§ 371 Date: Dec. 10, 2012

(30) Foreign Application Priority Data
Jun. 11, 2010 (DE) 102010023421.4

(51) Int. Cl. A23L 1/275

(52) U.S. Cl. CPC A23L 1/2753
USPC 426/250; 426/602; 426/540; 426/599

(57) ABSTRACT

The invention relates to an emulsion comprising an aqueous phase and an oil phase having a liposoluble colorant and comprising an emulsifier composition for emulsification of the liposoluble colorant in a foodstuff. In order to further develop the emulsion in such a manner that it has a very high transparency and a stable colouration, and in order to provide an emulsifier composition for a colorant emulsion which also has a high acidic stability in very acidic drinks in the range of pH≦3.5, the invention proposes that an emulsifier in the aqueous phase is a quillaia extract and the aqueous phase comprises at least one polyol and/or at least one sugar alcohol and preferably comprises lecithin in the oil phase.

### CROSS-REFERENCE TO RELATED APPLICATIONS

This patent application is a national stage filing under 35 U.S.C. 371 of International Application No. PCT/EP2011/059398, filed Jun. 7, 2011, which claims foreign priority to German Patent Application No. 102010023421.4, filed Jun. 11, 2010, the entire contents of which are hereby incorporated by reference. Priority is claimed to each of these applications.

### FIELD

The invention relates to a colorant emulsion according to the preamble of claim 1, a method for the preparation thereof and uses of the colorant emulsion as well as an emulsifier composition for this purpose.

### BACKGROUND

An emulsion is disclosed in the European Patent No. 19 722 06. The corresponding application in the USA is U.S. 2008/0260919 A1.

This previously known emulsion comprises an oil phase dispersed in an aqueous phase wherein the oil phase comprises a liposoluble colorant.

The oil phase additionally consists of an emulsifier composition for emulsification of the liposoluble colorant in a foodstuff which in each case, relative to the weight of the emulsifier composition, comprises between 10 and 90 wt. % or between 45 and 55 wt. % of at least one lecithin and between 10 and 90 wt. % or between 45 and 55 wt. % of at least one saccharose ester of fatty acids.

The fatty acid is in this case selected from the group which comprises palmitic acid, stearic acid, oleic acid, lauric acid and erucic acid, where the lecithin is selected from the group consisting of phosphatidylcholine, phosphatidylethanolamine and phosphatidylinositol.

This emulsion known from EP 19 722 06 is characterized in particular in that the emulsion has a higher transparency and a better color intensity than known emulsions of food colorants.

The choice of an emulsifier depends on the properties of the medium to be dissolved and the liposoluble colorant. When using liposoluble colorants for colouring fruit juices, it should be noted for example that fruit juices can bring about a destruction of the emulsifier. For this reason the use of acid-stable emulsifiers is desirable.

However, most recent studies have shown that the sugar ester used in EP 19 722 06 has only a limited stability in very acidic drinks, for example, below pH 3.5. In addition, it has been shown that the use of the sugar ester does not completely result in a desired approximately transparent and stable colouring.

### SUMMARY

It is therefore the object of the invention to eliminate these disadvantages of the prior art. In particular, a colorant emulsion is to be proposed which has a very high transparency and a stable colouring. In addition, an emulsifier composition for a colorant emulsion is to be provided which also has a high acid stability in very acidic drinks, for example, below pH 3.5.

This object is solved by the feature of claim 1. Advantageous embodiments of the invention are manifest in the dependent claims .

### DETAILED DESCRIPTION

The invention provides that an emulsifier in the aqueous phase is a quillaia extract and the aqueous phase comprises at least one polyol and/or at least one sugar alcohol.

The essential idea of the invention is to use a quillaia extract in combination with a polyol and/or a sugar alcohol, where preferably lecithin can be used as emulsifier in the oil phase.

According to the invention, an emulsifier composition is thus provided for emulsification of at least one liposoluble colorant in a foodstuff, wherein the emulsifier composition comprises at least one quillaia extract.

Within the framework of the studies on the emulsion according to the invention, the emulsifier “quillaia extract E 999” now licensed for drinks in Europe was tested in a 20% diluted aqueous solution.

The effective surface-active components in quillaia extracts are saponins which can be obtained by means of aqueous extraction methods from the quillaia tree. A distinction is made here between quillaia extracts of type 1 and type 2. A quillaia extract of type 1 is obtained by aqueous extraction from the comminuted bark or from wood from the quillaia tree and subsequent purification. The total saponin content in the type 1 extract is about 20 to 25%. A quillaia extract of type 2 is subjected to additional purification steps such as, for example, an ultrafiltration, membrane filtration or affinity chromatography. The saponin content in the type 2 extract is higher than in type 1. Type 1 is therefore less purified than type 2.

A quillaia extract of type 2 is preferably used in the present invention. The total saponin content of the quillaia extract used preferably is in the range of 65% to 90% relative to the dry substance.

The composition of the emulsifier found according to the invention is in particular characterized by a high acid stability in very acidic drinks having a pH-value in the range of ≦3.5, in particular in the pH range of 2.5 to 3.5. In addition, the emulsifier composition according to the invention is an efficient system for emulsification of liposoluble colorants insofar as in particular in drinks, preferably in soft drinks, a luminous yellow, approximately transparent and stable colouration is achieved.

In particular, the emulsion according to the invention results in a particularly fine droplet size in the oil phase with dissolved natural colorants, which preferably have a droplet size of 50 nm to 600 nm, more preferably <200 nm.

It has been shown that lecithin promotes the formation of the emulsion.

The term “Lecithin” is understood here as a substance according to EC Number E 322 (see Office for Official Publications of the European Communities, CONSLEG: 1996L0077—20 Nov. 2003). According to this, lecithin is defined as a mixture or fraction of phosphatides which are obtained by means of physical methods from animal or vegetable foodstuffs. Lecithins also comprise the hydrolized substances obtained with safe and suitable enzymes. The end product must not have any enzymatic residual activity. The terms “phosphatides” and “phospholipids” are used as synonyms for lecithins.

The lecithin is preferably selected from the group which comprises phosphatidylcholine, phosphatidylethanolamine and phosphatidylinositol. The lecithin being phosphatidylcholine is especially preferred. According to a further embodiment, the emulsifier composition comprises lecithins according to E 473.

The liposoluble colorant is preferably a food colorant, in particular a colorant selected from the group which comprises carotenoids, chlorophylls or combinations of these. In a particularly preferred embodiment the liposoluble colorant is a carotenoid. The carotenoid can be selected from the group which comprises bixin, capsanthin, capsorubin, lutein, rhodoxanthin and combinations of these.

The emulsion according to the invention, as already explained, has a high transparency as a result of the small particle size. In a preferred embodiment the emulsion is transparent. It can further be provided that the emulsion when used, e.g. in drinks, reaches a turbidity coefficient (FNU value) of less than 40 and in the spectral photometric analysis at 700 nm an absorption coefficient of less than 0.1 is achieved. The FNU value (“Formazine Nephelometric Unit”) is a parameter for the turbidity measurement.

The food colorant preferably is a carotenoid. A particularly preferred food colorant is β-carotene. The invention is not restricted to food colorants but can also comprise liposoluble colorants which are not food colorants as the oil phase.

The emulsion according to the invention is preferably added to a drink, in a dosage of 0.05 g/kg to 2 g/kg of drink. Thus, a transparent colouring is achieved.

It has proved particularly advantageous according to the invention if so much type 2 quillaia extract is added to the end product, in particular a drink, that a total content of saponin in the range of 5 ppm to 15 ppm exists. Such a small quantity of saponins already has the result that a stable emulsion is obtained, i.e. the resulting emulsifier composition has a surprisingly high acid stability. This is completely unexpected for the person skilled in the art since for example, quillaia extracts of type 1 are usually used in soft drinks as foaming agents having concentrations of 100 ppm to 250 ppm. This means that with an assumed saponin fraction of 20% (quillaia extract of type 1) a total content of about 20 ppm to 50 ppm of quillaia saponins must be used to produce foam formation. According to the invention, in comparison significantly lower concentrations in a drink are already sufficient to obtain a stable emulsion.

According to the invention the quillaia extract of type 2 is preferably present in a concentration of 5 ppm to 50 ppm, preferably 7.5 ppm to 30 ppm, quite particularly preferably >10 ppm to 25 ppm in a foodstuff, preferably a drink, quite particularly preferably an acidic drink.

Another advantage of the emulsifier according to the present invention is that no “ring formation” occurs during storage of drinks coloured with the emulsion in PET plastic bottles. This behaviour is also designated as “bottle staining” and “neck ringing effect”. In contrast to the emulsifier provided according to the invention, these disadvantageous effects occur very frequently in emulsions so that these products are then declined by the consumer. An emulsifier combination of sugar esters and lecithin according to EP 19 722 06 explained initially also exhibits this disadvantage of “ring formation”.

The emulsifier composition preferably comprises (a) between 0.5% and 3% of the at least one lecithin and (b) between 15% and 30% of the at least one quillaia extract, where the percentage information relates to the total formulation of the colorant preparation.

The quillaia extract is therefore preferably an extract 20% dissolved in water.

Emulsions having a dispersed oil phase, whose mean oil droplet size is less than or equal to 200 nm can be prepared by means of high-pressure homogenizers known per se. In this case, a crude emulsion or suspension is conveyed, for example, by means of a triple-piston pump at a pressure of up to 900 bar through a nozzle system. Extreme shear and stretching forces ensure an efficient comminution and a narrow droplet size distribution. A high-turbulence mixing chamber ensures stabilization of the droplets and minimizes perturbing coalescence effects. The emulsion according to the invention is preferably prepared at a pressure of 200 bar to 900 bar.

The preparation is explained in detail hereinafter by reference to examples:

### Preparation of the Emulsion According to the Invention

For preparation of the emulsion according to the invention, the following formulation is prepared and processed as described in the following, the percentage information relating to the overall formulation.

| | Designation | in % |
|---|---|---|
| Water phase | Glycerol | 40.00%-80.00% |
| | (higher alcohol) | |
| | Sorbitol | |
| | (sugar alcohol) | |
| | Quillaia extract | 15.00%-30.00% |
| | 20% dissolved in water | |
| Oil phase | Vegetable oil | 2.00%-20.00% |
| | Tocopherol | 1%-3% |
| | (antioxidant) | |
| | Lecithin | 0.5%-5% |
| | (co-emulsifier) | |
| | Carotene 30% | 1%-10% |
| | (colorant, active substance) | |

The quillaia extract is preferably a 20% extract dissolved in water.

1. Preparation of Water Phase

Glycerine and quillaia extract are mixed and heated to 40° C. whilst stirring continuously by means of a laboratory propeller stirrer at about 350 rpm (revolutions per minute).

2. Preparation of Oil Phase

Tocopherol, vegetable oil, lecithin and carotene are mixed and heated to 140° C. and kept for 5 min whilst stirring continuously. By monitoring the micro-image (1000×) it has to be ensured that all the β-carotene crystals are dissolved.

3. Preparation of the Emulsion by Addition of Oil to Water

The oil phase is slowly but continuously added to the water phase in the course of a mixing step whilst dispersing by means of Ultra-Turrax at 500 rpm (revolutions per minute). This is then followed by a pre-emulsification at 10,000 rpm (revolutions per minute) for 5 min. The particle size distribution and the micro-image of the pre-emulsion are monitored. Here 90% of the particles are to have a size of <1.5 μm (target specification: 90.00%<1.5 μm).

This is then directly followed by a treatment with the high-pressure homogenizer at 50/350 bar in 2 passes. The particle size distribution (target specification: 90.00%<1.0 μm) and the micro-image (blank) as well as the turbidity value (c=0.02%→<40 FNU) of the emulsion are then monitored again. The term “micro-image” is to be understood in the present context as the magnified image in the microscope, i.e. when viewed on the microscope slide to which the (pre-) emulsion was applied, for example, in 100-fold and/or 1000-fold magnification.

4. Evaluation of the Stability

It has been shown that the emulsion according to the invention was stable for 9 months or 5 weeks, respectively, in the storage test at 5° C. and 40° C. In addition, the particle size measurements and the spectral photometric analyses confirm that the emulsion according to the invention shows no phase separation and remains stable without any indication of a colorant degradation.

1. An emulsion comprising an aqueous phase, an oil phase, wherein said oil phase comprises a liposoluble colorant, and an emulsifier composition for emulsification of the liposoluble colorant in a foodstuff, characterized in that an emulsifier in the aqueous phase is a quillaia extract, and in that the aqueous phase comprises at least one polyol and/or at least one sugar alcohol.

2. The emulsion according to claim 1, characterized in that the quillaia extract is of type 2.

3. The emulsion according to claim 1 or 2, characterized in that an emulsifier in the oil phase is lecithin.

4. The emulsion according to any one of the preceding claims, characterized in that the polyol is a glycerol.

5. The emulsion according to any one of the preceding claims, characterized in that the sugar alcohol is a sorbitol and/or a glycerol.

6. The emulsion according to any one of the preceding claims, characterized in that the emulsion has been prepared at a pressure of 200 bar to 900 bar, preferably by means of a high-pressure homogenizer.

7. The emulsion according to any one of the preceding claims, characterized in that the emulsion is transparent for light of a wavelength in the visible range for the human eye.

8. The emulsion according to any one of the preceding claims, characterized in that the emulsion has an absorption coefficient of less than 0.1 at 700 nm.

9. The emulsion according to any one of the preceding claims, characterized in that the colorant is a food colorant, preferably a carotenoid or a β-carotene.

10. The emulsion according to any one of the preceding claims, characterized in that in addition to quillaia extract dissolved in water, the aqueous phase additionally consists of a higher alcohol such as glycerol and/or a sugar alcohol such as sorbitol.

11. The emulsion according to any one of the preceding claims, characterized in that the quillaia extract is a 20% extract dissolved in water.

12. The emulsion according to any one of the preceding claims, characterized in that the mean size of the oil droplets in the emulsion is 50 nm to 600 nm, preferably <200 nm.

13. The emulsion according to any one of the preceding claims, characterized in that the lecithin of the emulsifier composition is phosphatidylcholine.

14. The emulsion according to any one of the preceding claims, characterized in that the emulsion comprises a carotenoid selected from the group comprising bixin, capsanthin, capsorubin, lutein, rhodoxanthin and combinations of these or that the emulsion comprises an alpha- and betacarotene, lycopene or apocarotenal and/or other liposoluble food colorants such as chlorophylls.

15. The emulsion according to any one of the preceding claims, characterized in that the emulsifier composition comprises
a) between 0.5% and 5% lecithin; and
b) between 15% and 30% quillaia extract.

16. The emulsion according to any one of the preceding claims, characterized in that the emulsifier composition comprises between 40% and 80% sugar alcohol such as glycerol and/or sorbitol.

17. The emulsion according to any one of the preceding claims, characterized in that the emulsion has a turbidity coefficient (FNU value) of 40 or less.

18. A method for preparing an emulsion according to any one of the preceding claims, characterized in that the emulsion is prepared by means of a high-pressure homogenizer at a pressure of 200 bar to 900 bar.

19. Use of an emulsion according to any one of claims 1 to 17 in a foodstuff.

20. The use according to claim 19, wherein the emulsion is used in a drink, preferably in an acidic drink, in particular an acidic drink having a pH-value of ≦3.5, said drink preferably comprising 0.05 g/kg to 2 g/kg of the emulsion.

21. The use according to claim 20, characterized in that in the drink a total content of saponins contained in the added quillaia extract is in the range of >5 ppm, preferably >10 ppm, particularly preferably 5 ppm to 15 ppm.

22. The use according to claim 20 or 21, characterized in that the drink has an absorption coefficient of 0.1 or less at 700 nm.

23. The use according to claim 20, 21 or 22, characterized in that the emulsion has a turbidity coefficient (FNU value) of 40 or less.

24. Use of an emulsifier composition in an emulsion according to any one of the preceding claims for emulsification of a carotenoid in a fruit drink or a fruit composition.

25. The use according to claim 24, characterized in that the lecithin is phosphatidylcholine.

26. An emulsion, in particular obtained using an emulsifier composition according to claim 1, characterized in that the emulsion has the following overall formulation:
a) Oil phase:

| | |
|---|---|
| Lecithin | 0.5% to 5% |
| Carotene | 1.0% to 10% |
| Vegetable oil | 2.0% to 20% |
| Tocopherol | 1.0% to 3%, |

b) Water phase:
higher alcohol such as glycerol
and/or sugar alcohol such as

| | |
|---|---|
| Sorbitol | 40% to 80% |
| Quillaia extract | 15% to 30% |

wherein preferably the quillaia extract is dissolved, in particular 20%, in water.

27. A drink, in particular fruit drink, which is preferably an acidic drink having a pH-value of ≦3.5, in particular 2.5 to 3.5, characterized in that the drink comprises an emulsion according to any one of the preceding claims.
